(19) United States
(12) Patent Application Publication
(10) Pub. No.: US 2022/0287056 A1
(43) Pub. Date: Sep. 8, 2022

(54) METHODS AND COMMUNICATIONS DEVICES

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 17/762,743

(22) PCT Filed: Sep. 16, 2020
(86) PCT No.: PCT/EP2020/075848

§ 371 Date: Mar. 23, 2022

(30) Foreign Application Priority Data
Oct. 1, 2019 (EP) 19200920.7

(51) Int. Cl. H04W 72/12; H04W 72/04; H04L 1/18; H04L 5/00

(52) U.S. Cl. CPC H04W 72/1263; H04W 72/1278; H04W 72/0446; H04L 1/1812; H04L 5/0053

(57) ABSTRACT

A method of operating a communications device configured to transmit data or receive data is provided. The method comprises determining a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots, decoding the plurality of downlink signals, determining that the communications device should transmit, for each of the downlink signals, a feedback signal indicating for the each of the downlink signals whether or not the each of the downlink signals was successfully received.

### BACKGROUND

### Field of Disclosure

The present disclosure relates to communications devices, infrastructure equipment and methods for the transmission of data by a communications device in a wireless communications network.

The present application claims the Paris Convention priority from European Patent Application number EP19200920.7, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever increasing range of devices associated with a wider range of data traffic profiles and types than existing systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems [1], as well as future iterations/releases of existing systems, to efficiently support connectivity for a wide range of devices associated with different applications and different characteristic data traffic profiles and requirements. One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit data or receive data. The method comprises determining a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots, decoding the plurality of downlink signals, determining that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface, determining that there is a collision between the sets of radio resources of at least two of the second control signals in a sub-slot of the wireless access interface, selecting, in response to determining that there is a collision between the sets of radio resources of at least two of the second control signals, one of the at least two second control signals to carry the feedback signals which were to be carried by each of the at least two second control signals, multiplexing the feedback signals which were to be carried by each of the at least two second control signals into the selected second control signal, and transmitting only the selected second control signal.

Embodiments of the present technique, which in addition to methods of operating communications devices relate to communications devices and circuitry for communications devices, allow for more efficient use of radio resources by a communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 shows an example of how a User Equipment (UE) may multiplex multiple Hybrid Automatic Repeat Request Acknowledgements (HARQ-ACKs) into a single Physical Uplink Control Channel (PUCCH);

FIG. 5 shows an example of sub-slot based HARQ-ACK PUCCHs;

FIG. 6 shows an example of intra-UE sub-slot PUCCH collisions;

FIG. 7 shows an example of how a collision may occur with a PUCCH that has already been scheduled;

FIG. 8 shows a part schematic, part message flow diagram representation of a wireless communications network comprising a communications device and an infrastructure equipment in accordance with embodiments of the present technique;

FIG. 9 illustrates how colliding HARQ-ACKs may use a PUCCH resource indicated by the last DL grant in accordance with embodiments of the present technique;

FIG. 10 illustrates how colliding HARQ-ACKs may use a PUCCH resource indicated by the last DL grant from among PUCCHs that cross the slot boundary in accordance with embodiments of the present technique;

FIG. 11 illustrates how colliding HARQ-ACKs may use a PUCCH resource indicated by the last DL grant having the highest capacity in accordance with embodiments of the present technique;

FIG. 12 shows how the last DL grant for two sub-slots may not result in a collision in accordance with embodiments of the present technique;

FIG. 13 shows how the last DL grant for two sub-slots may result in a collision in accordance with embodiments of the present technique;

FIG. 14 shows how a collision may occur between two PUCCHs that do not physically overlap in accordance with embodiments of the present technique; and

FIG. 15 shows a flow diagram illustrating a process of communications in a communications system in accordance with embodiments of the present technique.

### DETAILED DESCRIPTION OF THE EMBODIMENTS

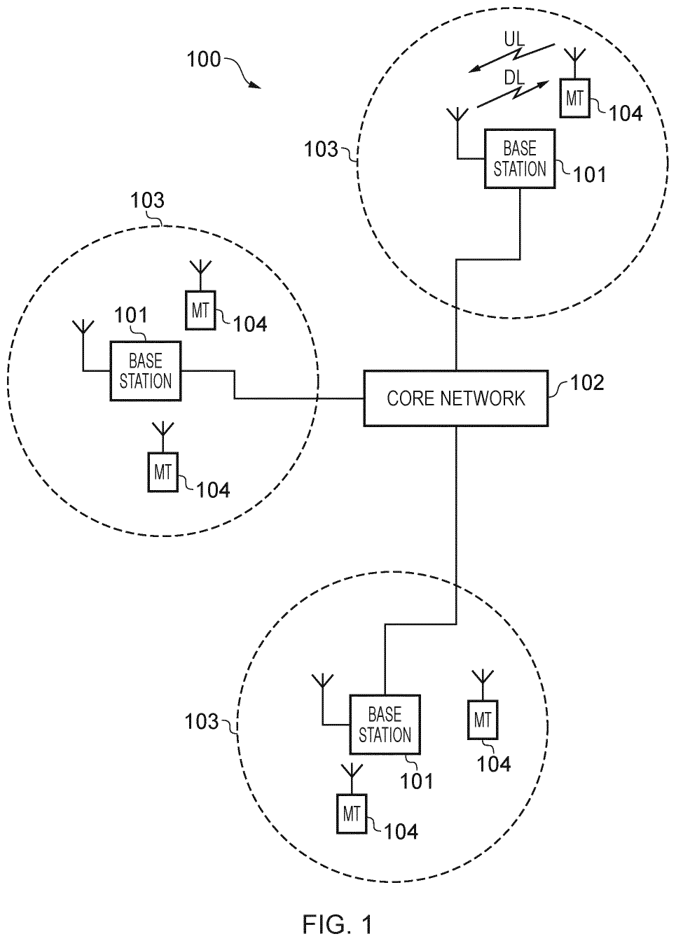

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture.

That is to say, the use of a specific term in relation to certain example implementations is not intended to indicate these implementations are limited to a certain generation of network that may be most associated with that particular terminology.

### New Radio Access Technology (5G)

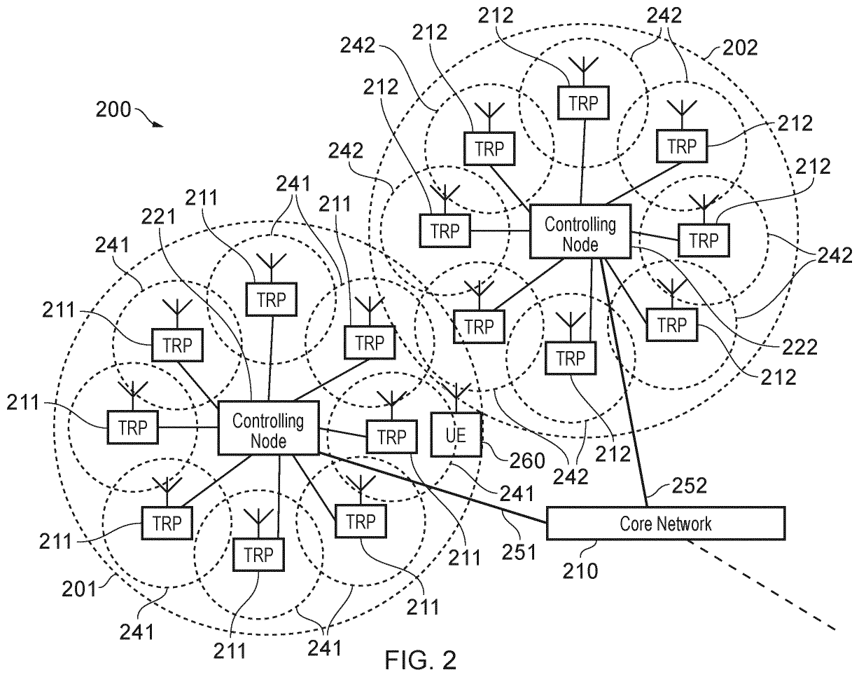

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

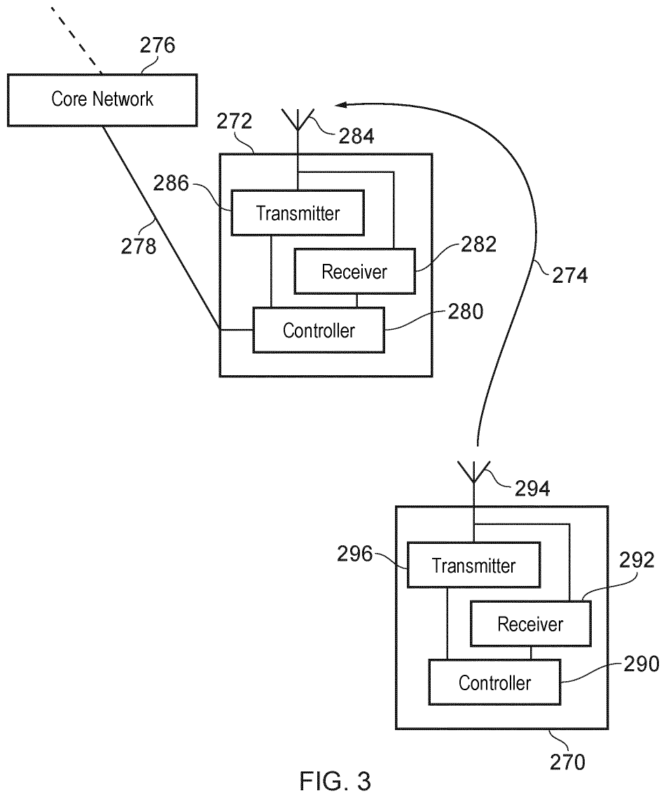

A more detailed illustration of a UE 270 and an example network infrastructure equipment 272, which may be thought of as an eNB 101 or a combination of a controlling node 221 and TRP 211, is presented in FIG. 3. As shown in FIG. 3, the UE 270 is shown to transmit uplink data to the infrastructure equipment 272 via resources of a wireless access interface as illustrated generally by an arrow 274. The UE 270 may similarly be configured to receive downlink data transmitted by the infrastructure equipment 272 via resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### 5G and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency

Communications (URLLC) services are for a reliability of 1-10⁻⁵ (99.999%) or higher for one transmission of a 32 byte packet is required to be transmitted from the radio protocol layer 2/3 SDU ingress point to the radio protocol layer 2/3 SDU egress point of the radio interface within 1 ms with a reliability of 99.999% to 99.9999% [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. It should be appreciated that the Uplink Control Information (UCI) for URLLC and eMBB will have different requirements. Hence, one of the current objectives of eURLLC is to enhance the UCI to support URLLC, where the aim is to allow more frequent Physical Uplink Control Channels (PUCCHs) carrying Hybrid Automatic Repeat Request Acknowledgement (HARQ-ACK) feedback per slot, and to support multiple HARQ-ACK codebooks for different traffic services.

### Hybrid Automatic Repeat Request Acknowledgements (HARQ-ACK)

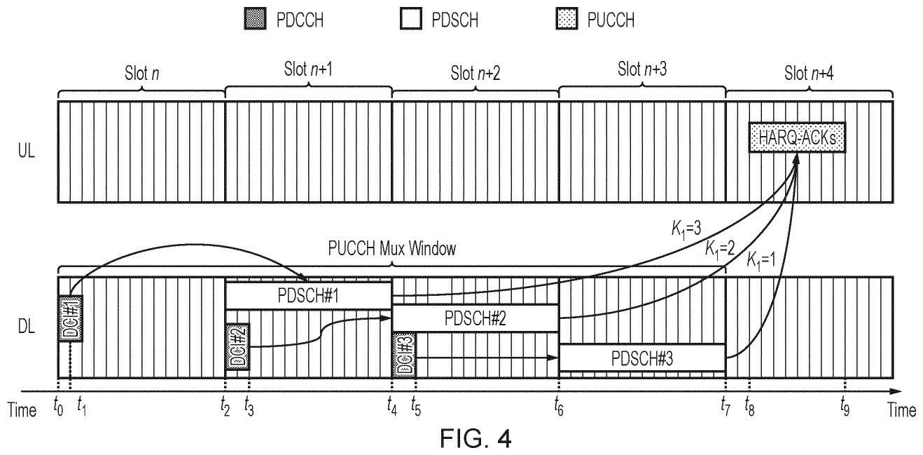

A HARQ-ACK feedback is transmitted to the gNB, in response to Physical Downlink Shared Channel (PDSCH) scheduling, to inform the gNB whether the UE has successfully decoded the PDSCH or not. For a PDSCH ending in slot n, the corresponding PUCCH carrying the HARQ-ACK is transmitted in slot n+K₁, where the value of K₁ is indicated in the field “PDSCH-to-HARQ_feedback timing indicator” of the DL Grant (carried by Downlink Control Information (DCI) Format 1_0 or DCI Format 1_1). Multiple (different) PDSCHs can point to the same slot for transmissions of their respective HARQ-ACKs and these HARQ-ACKs (in the same slot) are then multiplexed by the UE into a single PUCCH. Hence, a PUCCH can contain multiple HARQ-ACKs for multiple PDSCHs. An example is shown in FIG. 4, in which three DL Grants are transmitted to the UE via DCI#1, DCI#2 and DCI#3 in slot n, n+1 and n+2 respectively. DCI#1, DCI#2 and DCI#3 schedule PDSCH#1, PDSCH#2 and PDSCH#3 respectively. DCI#1, DCI#2 and DCI#3 further indicate K₁=3, K₁=2 and K₁=1 respectively. Since the K₁ values indicate that the HARQ-ACK feedbacks for PDSCH#1, PDSCH#2 and PDSCH#3 are all transmitted in slot n+4, the UE multiplexes all three of these HARQ-ACKs into a single PUCCH. The PUCCH Multiplexing Window is a time window during which PDSCHs can be multiplexed into that single PUCCH, where this PUCCH Multiplexing Window depends on the range of K₁ values. In the example shown by FIG. 4, the PUCCH Multiplexing Window is from Slot n to Slot n+3, which means the max K₁ value is 4 slots.

The PUCCH resource is determined based on the DL Grant scheduling the last PDSCH in the PUCCH Multiplexing Window, since the UE only knows the total number of HARQ-ACK bits after the last PDSCH is received. Additionally, the UE follows the PUCCH Resource Indicator (PRI) in the DL Grant of the last PDSCH to determine which PUCCH resource within a PUCCH resource set to use. In the example in in FIG. 4, the last PDSCH in the PUCCH Multiplexing Window is PDSCH#3 and the corresponding DL Grant is DCI#3.

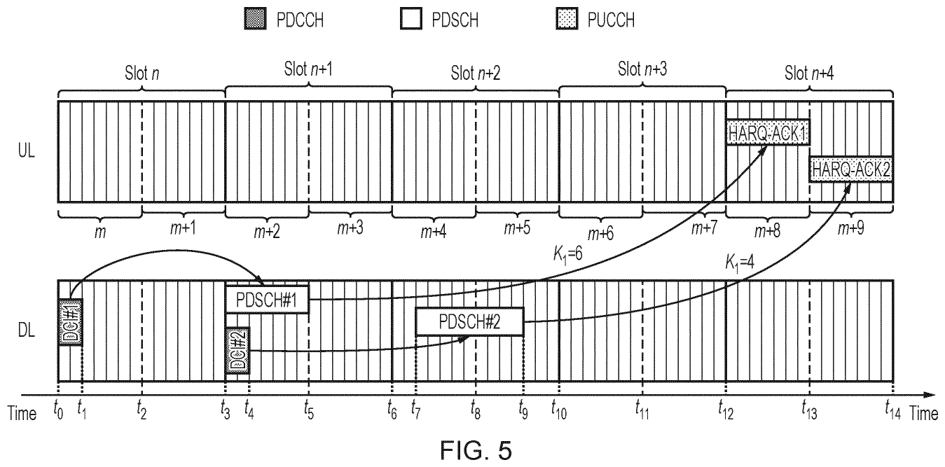

In Rel-16 eURLLC, the concept of sub-slots is introduced for PUCCH carrying HARQ-ACK for URLLC PDSCH. That is, the granularity of the K₁ value (i.e. the time difference between end of PDSCH and the start of its corresponding PUCCH) is smaller than a slot. An example is shown in FIG. 5, where the sub-slot size=7 symbols (i.e. half a slot) and the sub-slots are labelled as m, m+1, m+2, etc. PDSCH#1 is transmitted in slot n+1 but for sub-slot based HARQ-ACK PUCCH, it is transmitted in sub-slot m+2 and here K₁=6, which means that the corresponding HARQ-ACK1is in sub-slot m+2+K₁=m+8. PDSCH#2 is transmitted in slot n+2 but occupies sub-slot m+4 and m+5. The reference for K₁ is relative to the sub-slot where the PDSCH ends and in this case PDSCH#2 ends in sub-slot m+5. The DL Grant in DCI#2 that schedules PDSCH#2 indicates a K₁=4 which schedules a PUCCH for its HARQ-ACK at sub-slot m+5+K₁=sub-slot m+9. It will be appreciated by those skilled in the art that although the sub-slot size used in the examples of FIGS. 4 and 5 is 7 symbols, this is only an example and the sub-slot size may be different, for example 2 symbols or 4 symbols.

### Sub-Slot PUCCH Collision

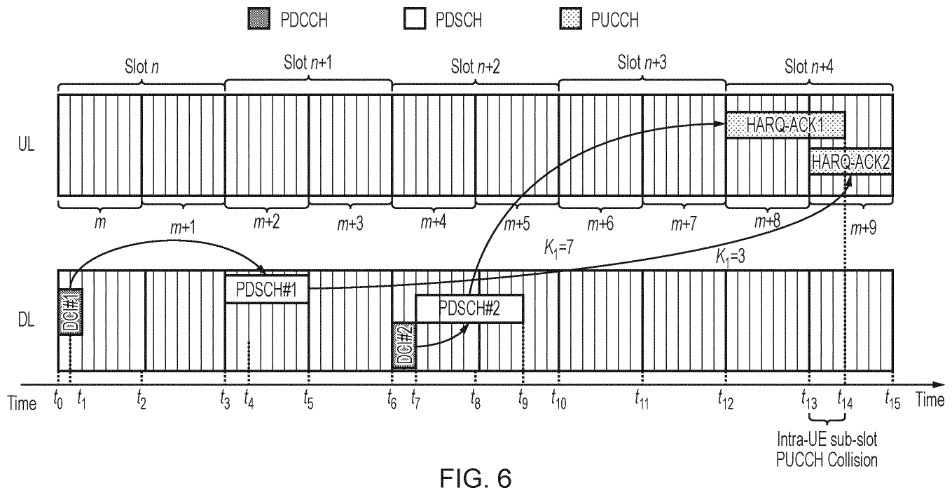

In the legacy system (Rel-15 NR), a PUCCH transmission does not cross the slot boundary, i.e., the PUCCH is wholly contained within a slot. However, for sub-slot based PUCCHs, there are proposals by various companies [4], [5], [6], to allow a sub-slot based PUCCH to cross the sub-slot boundary. This provides flexibility in scheduling the PUCCH duration, especially for small sub-slot sizes (e.g. 2 OFDM symbol sub-slot size), i.e. allowing the PUCCH duration to be longer than the sub-slot size for coverage purpose. An example is shown in FIG. 6 where DCI#1 schedules PDSCH#1 with a corresponding HARQ-ACK1 carried by a PUCCH in sub-slot m+8. Here, the sub-slot size is 7 OFDM symbols but the PUCCH carrying HARQ-ACK1 has a duration of 10 OFDM symbols thereby crossing the sub-slot boundary (boundary between sub-slot m+8 and m+9).

When a sub-slot PUCCH crosses the sub-slot boundary, it can collide with another sub-slot PUCCH in the subsequent sub-slot. Referring to FIG. 6 again, a DCI#2 furthers schedules PDSCH#2 with a corresponding HARQ-ACK2 carried by a PUCCH in sub-slot m+9, which collides with the PUCCH (carrying HARQ-ACK1) that started in sub-slot m+8, between time t₁₃ and t₁₄. Some proposals have been made to address this issue.

In [4], it is proposed to make the later (collided sub-slot) invalid and any HARQ-ACKs scheduled in that sub-slot are dropped. Using the example shown in FIG. 6, HARQ-ACK2 scheduled in sub-slot m+9 is dropped since it collides with HARQ-ACK1 that started in sub-slot m+8. Dropping HARQ-ACKs leads to delay which is not desirable for low latency traffic such as URLLC.

In [5] and [6], it is suggested that the gNB can avoid such collisions, i.e. if gNB schedules a PUCCH to cross the sub-slot boundary i.e. occupying part of the later sub-slot, then the gNB will avoid scheduling any further PUCCHs in the later sub-slot. Using the example in FIG. 6, where HARQ-ACK1 occupies sub-slots m+8 and m+9, it is argued that the gNB can avoid scheduling HARQ-ACK2 in sub-slot m+9 by scheduling it in either sub-slot m+8 (thereby multiplexing it with the PUCCH in sub-slot m+8) or delay HARQ-ACK2 to another sub-slot. There are problems with this approach.

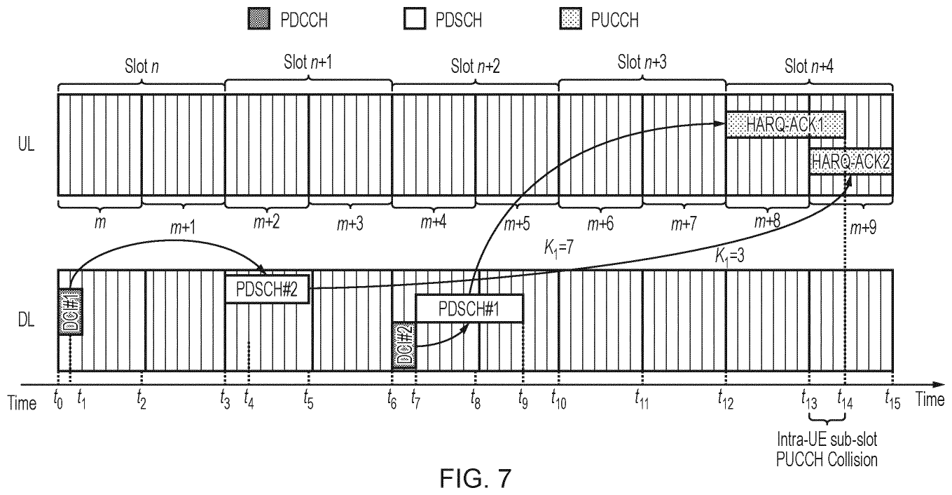

Firstly, it assumes that the gNB always schedules the later sub-slot (m+9) after it has scheduled the earlier sub-slot (m+8). However, this may not be the case; that is, HARQ-ACK2 may have already been scheduled to occur in sub-slot m+9 BEFORE HARQ-ACK1 is being scheduled. This scenario is shown in FIG. 7, where DCI#1 schedules PDSCH#2, where K₁=7, thereby scheduling the PUCCH carrying HARQ-ACK2 in sub-slot m+9. DCI#2 then schedules PDSCH#1, with K₁=3, thereby scheduling the PUCCH carrying HARQ-ACK1 in sub-slot m+8. HARQ-ACK1 is scheduled to use a PUCCH with a duration of 10 OFDM symbols, thereby causing a collision with sub-slot m+9. Here, HARQ-ACK1 collides with an already scheduled HARQ-ACK2 and so the gNB cannot reschedule this HARQ-ACK2 to occur in another sub-slot.

Secondly, delaying HARQ-ACK2 to a further sub-slot introduces delay which is not desirable for low latency traffic such as URLLC. Also, subsequent sub-slots may already have a lot of HARQ-ACKs which would increase the load if HARQ-ACK2 is multiplexed into them.

Embodiments of the present technique propose solutions to resolve collisions due to a sub-slot based PUCCH crossing the sub-slot boundary, in an efficient and robust manner.

### Overlapping Sub-Slot Based PUCCHs

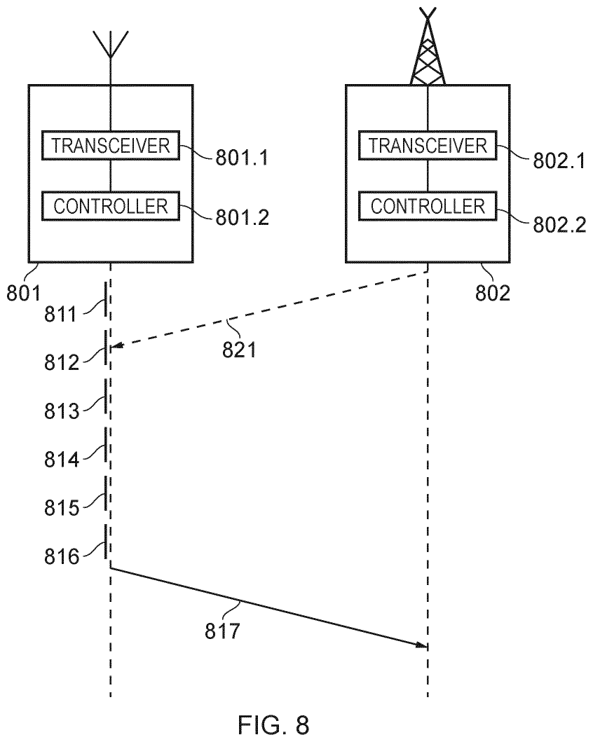

FIG. 8 shows a part schematic, part message flow diagram representation of a wireless communications network comprising a communications device 801 and an infrastructure equipment 802 in accordance with at least some embodiments of the present technique. The communications device 801 is configured to transmit data to or receive data from an infrastructure equipment 802, via a wireless access interface provided by the wireless communications network. The communications device 801 and the infrastructure equipment 802 each comprise a transceiver (or transceiver circuitry) 801.1, 802.1, and a controller (or controller circuitry) 801.2, 802.2. Each of the controllers 801.2, 802.2 may be, for example, a microprocessor, a CPU, or a dedicated chipset, etc.

As shown in the example of FIG. 8, the transceiver circuitry 801.1 and the controller circuitry 801.2 of the communications device 801 are configured in combination to determine 811 a plurality of sets of radio resources of a wireless access interface in each of which the communications device 801 is to receive 821 (from the infrastructure equipment 802) one of a plurality of downlink signals, wherein the wireless access interface is formed of a plurality of time divided slots, each of the time divided slots being further divided into two or more sub-slots, to decode 812 the plurality of downlink signals 821, to determine 813 that the communications device 801 should transmit, for each of the downlink signals 821 (and to the infrastructure equipment 802), a feedback signal indicating for the each of the downlink signals 821 whether or not the each of the downlink signals 821 was successfully received (from the infrastructure equipment 802), wherein the communications device 801 is to transmit (to the infrastructure equipment 802) the feedback signals within a plurality of second control signals, one or more of the feedback signals to be transmitted (to the infrastructure equipment 802) within each of the second control signals, each of the second control signals being associated with at least one of the plurality of downlink signals 821 and being transmitted (to the infrastructure equipment 802) by the communications device 801 in a set of radio resources of the wireless access, to determine 814 that there is a collision between the sets of radio resources of at least two of the second control signals in a sub-slot of the wireless access interface, to select 815, in response to determining that there is a collision between the sets of radio resources of at least two of the second control signals, one of the at least two second control signals to carry the feedback signals which were to be carried by each of the at least two second control signals, to multiplex 816 the feedback signals which were to be carried by each of the at least two second control signals into the selected second control signal, and to transmit 817 only the selected second control signal (to the infrastructure equipment 802).

Essentially, embodiments of the present technique propose that the HARQ-ACKs belonging to the intra-UE (i.e. the collision is between HARQ-ACKs relating to received signals by the same UE) colliding sub-slot PUCCHs are multiplexed into a PUCCH using a PUCCH resource corresponding to one of the PDSCHs with a colliding HARQ-ACK. Alternatively, it may be said that embodiments of the present technique propose that the sub-slots of the colliding (sub-slot based) PUCCHs are merged and all the colliding HARQ-ACKs are multiplexed into a single PUCCH where the resource of this PUCCH is determined by one of the PDSCHs with the colliding HARQ-ACK.

In an arrangement of embodiments of the present technique, the said one of the PDSCHs is the PDSCH scheduled by the last DL Grant of the DL Grants where their sub-slot PUCCH collides. This DL Grant can schedule PUCCH in the earlier or later sub-slot. The colliding HARQ-ACKs are then multiplexed into the PUCCH resource indicated by that last DL Grant. In other words, the selecting the one of the at least two second control signals to carry the feedback signals which were to be carried by each of the at least two second control signals comprises determining which of the one of the at least two second control signals is associated with the most recently received one of the plurality of downlink signals (this most recently received one of the plurality of downlink signals may be the PDSCH for which the PUCCH comprises HARQ-ACK feedback, or may be the DL Grant that schedules that PDSCH), and selecting the determined one of the at least two second control signals as the selected second control signal.

In some implementations of this arrangement, if the PUCCH resource of the last DL Grant starts in the later sub-slot, then the multiplexed PUCCH is shifted to start in the earlier sub-slot. In other words, if the set of radio resources of the selected second control signal starts in a sub-slot that is not a first sub-slot of one of the slots of the wireless access interface, the communications device is configured to transmit the selected second control signal in the first sub-slot of the one of the slots of the wireless access interface.

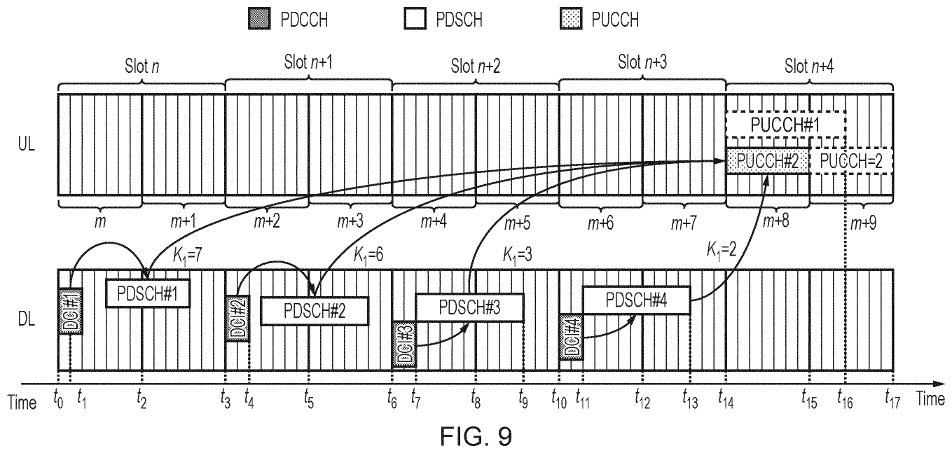

Another way to describe this is that the colliding sub-slots are merged and the PUCCH resource used is that indicated by the last DL Grant with PUCCH in the merged sub-slot. By using the last DL Grant to determine the final PUCCH, it allows the gNB to decide on the best PUCCH resource to use after it knows how many HARQ-ACKs need to be multiplexed. An example is shown in FIG. 9, where DCI#1, DCI#2, DCI#3 & DCI#4 schedules PDSCH#1, PDSCH#2, PDSCH#3 & PDSCH#4 respectively. The DL

Grant parameters used by these DCIs are summarized in Table I below.

TABLE I
DL Grant parameters (PUCCH follows last DL Grant)

| | | PUCCH | PUCCH Duration | Offset from sub- |
|---|---|---|---|---|
| DCI | K₁ | Sub-slot | (symbols) | slot boundary |
| DCI#1 | 7 | m + 8 | 10 | 0 |
| DCI#2 | 6 | m + 9 | 7 | 0 |
| DCI#3 | 3 | m + 8 | 10 | 0 |
| DCI#4 | 2 | m + 9 | 7 | 0 |

The HARQ-ACK feedbacks for PDSCH#1 & PDSCH#3 are scheduled to be carried by PUCCH#1 in sub-slot m+8 which has a duration of 10 symbols, thereby crossing the sub-slot boundary. The HARQ-ACK for PDSCH#2 and PDSCH#4 are initially scheduled to be carried by PUCCH#2 in sub-slot m+9. PUCCH#1 collides with PUCCH#2 and so as per this arrangement, the PUCCH resource to use is determined by the last DL Grant, which in this example is DCI#4. As per the above-described implementations of this arrangement, where the multiplexed PUCCH is shifted to start in the earlier sub-slot, PUCCH#2 which starts in the later sub-slot m+9 is then shifted to the earlier sub-slot m+8. That is all the colliding HARQ-ACKs are multiplexed into PUCCH#2 which starts its transmission in sub-slot m+8.

It should be noted by those skilled in the art that the PUCCH may start with an offset from the sub-slot boundary. The example of FIG. 9 just shows that the PUCCH starts with symbol offset of 0 from the sub-slot boundary. It should also be appreciated that this arrangement can be extended to more than 2 colliding sub-slots, e.g. for 3 colliding sub-slot PUCCHs, the HARQ-ACKs scheduled to these 3 colliding sub-slot PUCCHs are multiplexed together using the PUCCH resource indicated by the last DL Grant where their HARQ-ACKs collide—where all three may collide simultaneously, or one of the PUCCHs may collide with both of the other PUCCHs separately.

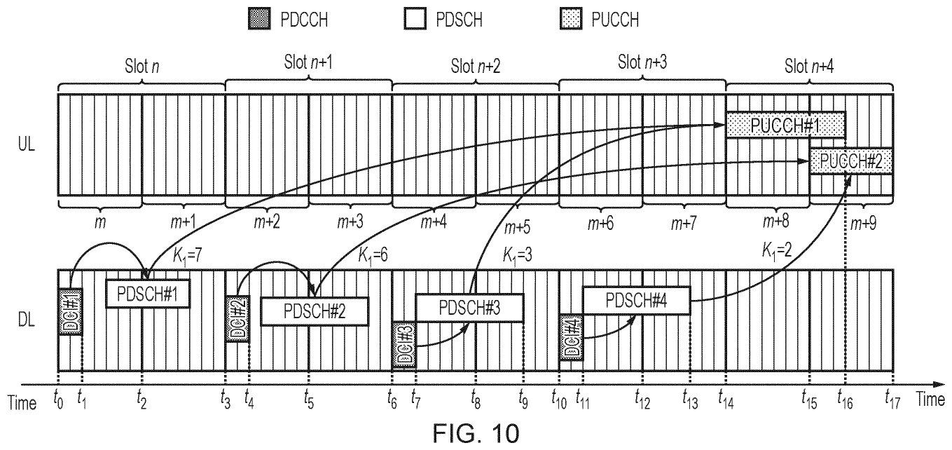

In another arrangement of embodiments of the present technique, the said one of the PDSCH is the PDSCH scheduled by the last DL Grant with a PUCCH in the earliest sub-slot that crosses the sub-slot boundary. In other words, the selecting the one of the at least two second control signals to carry the feedback signals which were to be carried by each of the at least two second control signals comprises determining that the sets of radio resources of the at least two second control signals are located within a plurality of the sub-slots of the wireless access interface, determining that the set of radio resources of one or more of the at least two second control signals extends between at least two of the plurality sub-slots, determining which of the one or more of the at least two second control signals starts in the earliest sub-slot of the plurality of sub-slots, and determining, from among the one or more of the at least two second control signals that starts in the earliest sub-slot of the plurality of sub-slots, which one is associated with the most recently received one of the plurality of downlink signals (this most recently received one of the plurality of downlink signals may be the PDSCH for which the PUCCH comprises HARQ-ACK feedback, or may be the DL Grant that schedules that PDSCH), and selecting the determined one of the one or more of the at least two second control signals as the selected second control signal. An example is shown in FIG. 10, where DCI#1, DCI#2, DCI#3 and DCI#4 schedules PDSCH#1, PDSCH#2, PDSCH#3 and PDSCH#4 respectively where their DL grants are as described in Table II below.

TABLE II
DL Grant parameters

| | | PUCCH | PUCCH Duration | Offset from sub- |
|---|---|---|---|---|
| DCI | K₁ | Sub-slot | (symbols) | slot boundary |
| DCI#1 | 7 | m + 8 | 9 | 0 |
| DCI#2 | 6 | m + 9 | 4 | 0 |
| DCI#3 | 3 | m + 8 | 10 | 0 |
| DCI#4 | 2 | m + 9 | 7 | 0 |

DCI#1 and DCI#3 both schedule PUCCHs in sub-slot m+8 and both cause the PUCCH to cross the sub-slot boundary. However, DCI#3 (shown in the third row of Table II) is the last DL Grant scheduling a PUCCH in sub-slot m+8 that crosses the sub-slot boundary thereby causing the collision and so this PUCCH is used to carry all the colliding HARQ-ACKs. That is, all the HARQ-ACKs for PDSCH#1, PDSCH#2, PDSCH#3 & PDSCH#4 are multiplexed into the PUCCH indicated in DCI#3 (PUCCH with duration of 10 symbols).

Another way to describe this arrangement is that the colliding sub-slots are merged and the PUCCH resource to use is based on the last scheduled PUCCH in the earlier (i.e. m+8) sub-slot. It should be appreciated that, similarly to the previously described arrangement, this arrangement can be extended to more than 2 colliding sub-slots, e.g. if PUCCH#2 also crosses the sub-slot boundary and collide with a further PUCCH#3, then all the colliding HARQ-ACKs are multiplexed into a single PUCCH where the resource of this PUCCH is indicated by the last DL Grant that causes the first PUCCH (i.e. PUCCH#1) to cross the sub-slot boundary.

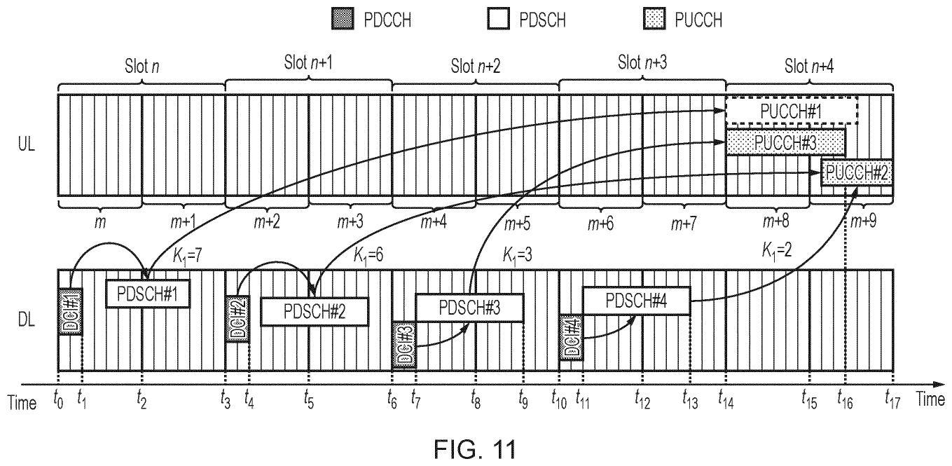

In another arrangement of embodiments of the present technique, the PUCCH resource is determined by the last DL Grants of the respective colliding sub-slot PUCCHs that has the largest capacity. In other words, the selecting the one of the at least two second control signals to carry the feedback signals which were to be carried by each of the at least two second control signals comprises determining that the sets of radio resources of the at least two second control signals are located within a plurality of the sub-slots of the wireless access interface, determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals (this most recently received one of the plurality of downlink signals may be the PDSCH for which the PUCCH comprises HARQ-ACK feedback, or may be the DL Grant that schedules that PDSCH) from among those of the at least two second control signals that start in that sub-slot, and selecting the one of the subset of the at least two second control signals having a highest capacity as the selected second control signal. An example is shown in FIG. 11 where DCI#1, DCI#2, DCI#3 & DCI#4 schedules PDSCH#1, PDSCH#2, PDSCH#3 & PDSCH#4 respectively. The DL Grant parameters are summarized in Table III overleaf.

At time to, DCI#1 schedules PUCCH#1 that starts in sub-slot m+8 with a duration of 11 symbols. DIC#2 and DCI#4 schedules PUCCH#2 that starts in sub-slot m+9 for the HARQ-ACK feedbacks of PDSCH#2 and PDSCH#4. At time t₆, DCI#3 schedules PUCCH#3 that starts in sub-slot m+8 with a duration of 10 symbols. Since DCI#3 is the last DL Grant for PUCCHs scheduled in sub-slot m+8, it overrides the PUCCH scheduling of previous (i.e. DCI#1) DL Grants with PUCCH in the same sub-slot. PUCCH#3 crosses the sub-slot boundary and collides with PUCCH#2. DCI#4 is the last DL Grant for PUCCHs scheduled in sub-slot m+9. Hence as per this embodiment, the UE will select either PUCCH#2 and PUCCH#3 based on their capacity. In this example PUCCH#3 has higher capacity than PUCCH#2 and so PUCCH#3 is selected to carry the HARQ-ACKs for PDSCH#1, PDSCH#2, PDSCH#3 & PDSCH#4. It should be noted that although PUCCH#1 has a higher capacity than PUCCH#3, PUCCH#3 is scheduled by the last DL Grant and so it is used instead of PUCCH#1.

TABLE III
DL Grant parameters (PUCCH uses last
DL Grant with the largest capacity)

| | | PUCCH | PUCCH Duration | Offset from sub- |
|---|---|---|---|---|
| DCI | K₁ | Sub-slot | (symbols) | slot boundary |
| DCI#1 | 7 | m + 8 | 11 | 0 |
| DCI#2 | 6 | m + 9 | 7 | 1 |
| DCI#3 | 3 | m + 8 | 10 | 0 |
| DCI#4 | 2 | m + 9 | 7 | 1 |

It should be appreciated that in this example it is assumed that the longer the PUCCH duration the larger the capacity but this is not the case since the capacity of a PUCCH is a combination of the number of PRBs, modulation, coding rate and duration. In other words, the capacity may be based on a temporal length of each of the second control signals, or the capacity may be based on a number of physical resource blocks forming each of the second control signals, or the capacity may be based on a modulation scheme used to form each of the second control signals, or the capacity may be based on a coding rate of each of the second control signals, or the capacity may be based on any combination or aggregation of these.

In another arrangement of embodiments of the present technique, the PUCCH resource is determined by the last DL Grants of the respective colliding sub-slot PUCCHs that has ends the earliest. In other words, the selecting the one of the at least two second control signals to carry the feedback signals which were to be carried by each of the at least two second control signals comprises determining that the sets of radio resources of the at least two second control signals are located within a plurality of the sub-slots of the wireless access interface, determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals (this most recently received one of the plurality of downlink signals may be the PDSCH for which the PUCCH comprises HARQ-ACK feedback, or may be the DL Grant that schedules that PDSCH) from among those of the at least two second control signals that start in that sub-slot, and selecting the one of the subset of the at least two second control signals that is scheduled to end at the earliest time as the selected second control signal. This is similar to the previously described arrangement where the UE selects one PUCCH scheduled by the last DL Grants of the colliding PUCCHs and the selection criterion is based on which PUCCH ends the earliest.

In some implementations of this arrangement, all the PUCCHs being considered are normalised to the earliest sub-slot. That is, if the collision involves two sub-slots, i.e. an earlier sub-slot and a later sub-slot, the symbol offset is relative to the sub-slot boundary of the earlier sub-slot. In other words, the selecting the one of the subset of the at least two second control signals that is scheduled to end at the earliest time as the selected second control signal comprises determining that the one of the subset of the at least two second control signals is scheduled to end at an earlier time relative to the start of the sub-slot in which the one of the subset of the at least two second control signals starts than each of the others of the subset of the at least two second control signal are scheduled to end relative to the start of the sub-slots in which they start. That is, the PUCCH resources of the later sub-slot are shifted to the earlier sub-slot (similar to the arrangement described above with respect to FIG. 9).

For this arrangement, and using the same example in FIG. 11, PUCCH#2 will be selected because it is the last DL Grant with PUCCH in sub-slot m+9 and that it would be the PUCCH that finishes the earliest if it is shifted to sub-slot m+8. It should be noted that the shortest PUCCH does not necessarily mean the one that ends the earliest. This is because a short PUCCH may have a large offset from the sub-slot boundary and therefore it may end later than a longer PUCCH that has a small offset from the sub-slot boundary.

The arrangements described with respect to FIGS. 9, 10 and 11 above all show that the resources for the PDSCH and PUCCH are indicated by a DL Grant carried in DCI, and in other words the communications device is configured to receive, via the wireless access interface, a plurality of first control signals each comprising an indication of the set of radio resources of the wireless access interface in which the communications device is to receive one of the plurality of downlink signals, and the determining of the sets of radio resources of the wireless access interface in each of which the communications device is to transmit one of the plurality of second control signals comprises receiving, in the first control signals, indications of the sets of radio resources of the wireless access interface in which the communications device is to transmit the uplink control signals (where the first control signals are DCI signals).

In another arrangement of embodiments of the present technique, the said PDSCH can be a Semi-Persistent Scheduling (SPS) based PDSCH. A SPS PDSCH is PDSCH that is transmitted using RRC configured resources, i.e. the PDSCH resource is semi-statically configured rather than dynamically indicated by a DL Grant. The PUCCH of the SPS PDSCH is also semi-statically configured. In other words, the communications device is configured to receive, via the wireless access interface, Radio Resource Control, RRC, signalling indicating the sets of radio resources of the wireless access interface in which the communications device is to receive the downlink signals, and the determining of the sets of radio resources of the wireless access interface in each of which the communications device is to transmit one of the plurality of second control signals comprises receiving, via the wireless access interface, RRC signalling indicating the sets of radio resources of the wireless access interface in which the communications device is to transmit the uplink control signals. This arrangement recognises that the last PDSCH with sub-slot PUCCH colliding with another sub-slot PUCCH can come from a SPS PDSCH. The above-described arrangements can all therefore be used with SPS based PDSCH.

### Definition of Sub-Slot Based PUCCH Collision

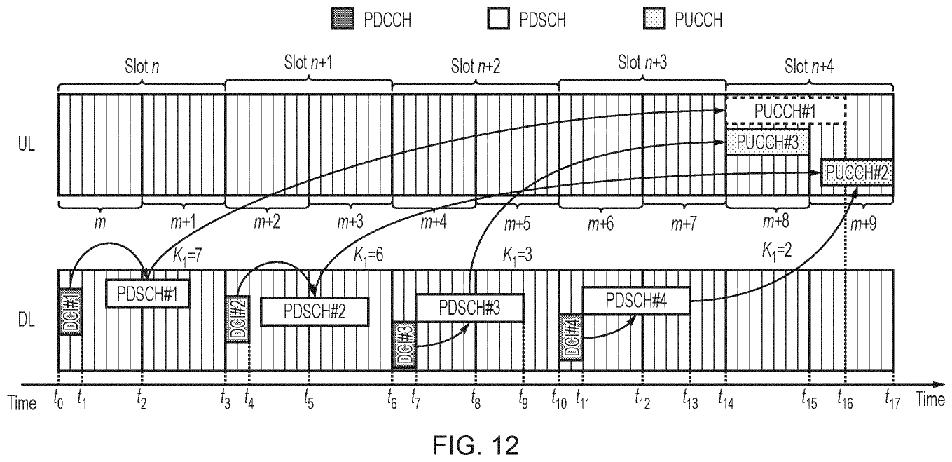

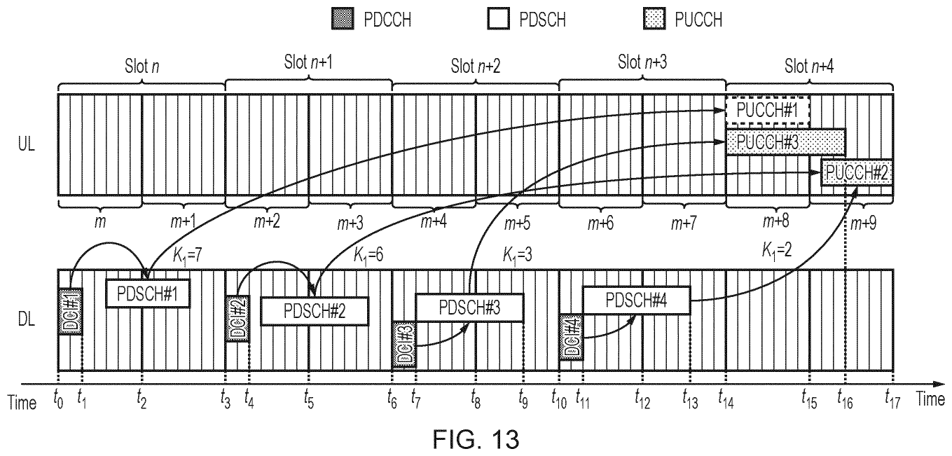

In the prior art (see for example [4], [5] and [6]) it has not been defined what a sub-slot PUCCH collision actually is. In at least some arrangements of embodiments of the present technique, two (or more) sub-slot based PUCCHs are in collision if the last PDSCH corresponding to each of the sub-slot based PUCCH resulted in their PUCCH colliding. In other words, the determining that there is a collision between the sets of radio resources of the at least two of the second control signals in a sub-slot of the wireless access interface comprises determining that the sets of radio resources of the at least two second control signals are located within a plurality of the sub-slots of the wireless access interface, determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals (this most recently received one of the plurality of downlink signals may be the PDSCH for which the PUCCH comprises HARQ-ACK feedback, or may be the DL Grant that schedules that PDSCH) from among those of the at least two second control signals that start in that sub-slot, and determining that the sets of radio resources of at least two of the subset of the at least two second control signals at least partially overlap in time. This recognises that the UE uses the last DL Grant of a PUCCH multiplexing window to determine its PUCCH resource. To explain this, we will show two examples: in FIG. 12 (without collision) and FIG. 13 (with collision).

In FIG. 12, DCI#1, DCI#2, DCI#3 & DCI#4 schedules PDSCH#1, PDSCH#2, PDSCH#3 & PDSCH#4 respectively using the DL Grant parameters summarized in Table IV below. At time to, DCI#1 schedules PUCCH#1 for the HARQ-ACK of PDSCH#1 using a PUCCH resource with a duration of 10 symbols in sub-slot m+8 thereby causing it to cross the sub-slot boundary into sub-slot m+9. Since no PUCCH is scheduled in sub-slot m+9 at time to, there is no PUCCH collision (yet). At time t₃, DCI#2 schedules PUCCH#2, a PUCCH in sub-slot m+9 with a duration of 6 symbols starting with a 1 symbol offset from the sub-slot boundary. Hence at time t₄ after DCI#2 is sent, there is a potential collision since PUCCH#1 collides with PUCCH#2. However, at time t₆ DCI#3 schedules PUCCH#3 which is 7 symbols long in sub-slot m+8 which thereby avoided a collision with PUCCH#2. At time t₁₀, the DCI#4 continued to use PUCCH#2 in sub-slot m+9 for the HARQ-ACK for PDSCH#4. Although an initial DL Grant (DCI#1) caused a collision, since the last DL Grant for sub-slot m+8 (DCI#3) and DL Grant for sub-slot m+9 (DCI#4) did not cause a collision, then no collision occur and so there is no need to multiplex the HARQ-ACKs in PUCCH#3 and PUCCH#2 together.

TABLE IV
DL Grant parameters for non-colliding PUCCH

| | | PUCCH | PUCCH Duration | Offset from sub- |
|---|---|---|---|---|
| DCI | K₁ | Sub-slot | (symbols) | slot boundary |
| DCI#1 | 7 | m + 8 | 10 | 0 |
| DCI#2 | 6 | m + 9 | 6 | 1 |
| DCI#3 | 3 | m + 8 | 7 | 0 |
| DCI#4 | 2 | m + 9 | 6 | 1 |

In FIG. 13, DCI#1, DCI#2, DCI#3 & DCI#4 schedules PDSCH#1, PDSCH#2, PDSCH#3 & PDSCH#4 respectively using the DL Grant parameters summarized in Table V below. At time to, DCI#1 schedules PUCCH#1 that is 7 symbols duration starting with 0 offset in sub-slot m+8, i.e. PUCCH#1 does not cross sub-slot boundary and hence there is no collision at this time. At time t₃, DCI#2 schedules PUCCH#2 that is 6 symbols duration starting with a 1 symbol offset from sub-slot m+9, and hence at this time there is still no collision. At time t₆, DCI#3 schedules PUCCH#3 which is 10 symbols long which start at 0 offset in sub-slot m+8 thereby crossing the slot boundary can causing a collision with PUCCH#2. At time t₁₀, DCI#4 continues to use PUCCH#3 in sub-slot m+9 for the HARQ-ACK of PDSCH#4. Since DCI#3 and DCI#4 are the last DL Grants for PUCCH in sub-slot m+8 and sub-slot m+9 respectively, then whether there is a collision depends on these two DL Grants and in this case their PUCCH scheduling cause a collision.

TABLE V
DL Grant parameters for colliding PUCCH

| | | PUCCH | PUCCH Duration | Offset from sub- |
|---|---|---|---|---|
| DCI | K₁ | Sub-slot | (symbols) | slot boundary |
| DCI#1 | 7 | m + 8 | 7 | 0 |
| DCI#2 | 6 | m + 9 | 6 | 1 |
| DCI#3 | 3 | m + 8 | 10 | 0 |
| DCI#4 | 2 | m + 9 | 6 | 1 |

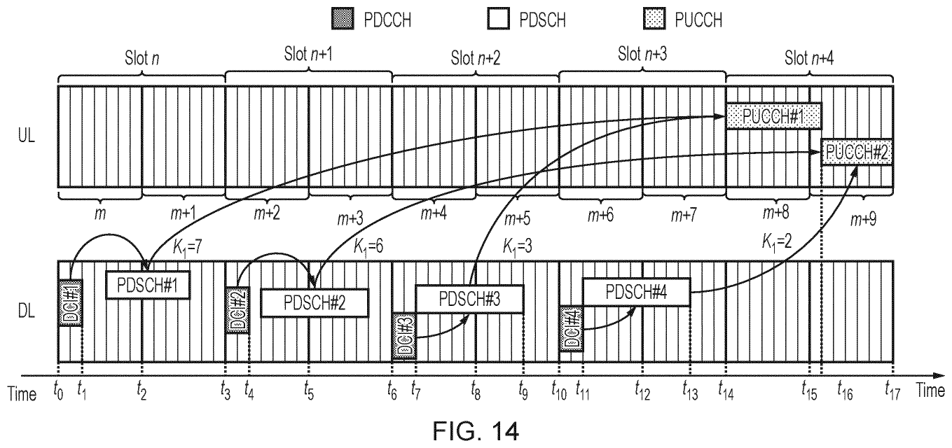

In at least some arrangements of embodiments of the present technique, if a sub-slot PUCCH of a 1^{st} sub-slot crosses into a subsequent 2^{nd} sub-slot and the 2^{nd} sub-slot contains another sub-slot PUCCH, then a collision happens even if these two PUCCH do not physically overlap in time. In other words, the determining that there is a collision between the sets of radio resources of the at least two of the second control signals in a sub-slot of the wireless access interface comprises determining that the sets of radio resources of the at least two second control signals are located within a plurality of the sub-slots of the wireless access interface, determining that a first of the at least two second control signals that starts in a first of the plurality of sub-slots extends into a second of the plurality of sub-slots, and determining that a second of the at least two second control signals starts in the second of the plurality of sub-slots. An example is shown in FIG. 14, where DCI#1 and DCI#3 schedules PUCCH#1 that is 9 symbols long in sub-slot m+8 for HARQ-ACKs of PDSCH#1 and PDSCH#3. DCI#2 and DCI#4 schedules PUCCH#2 that is 6 symbols long that starts with a 1 symbol offset from the boundary of sub-slot m+9. Although PUCCH#1 and PUCCH#2 do not overlap in time, this embodiment considers that a collision had happened.

In some implementations of the above described arrangements, a collision occurs only if a PUCCH that crosses sub-slot boundary physically overlap in time with a PUCCH in the subsequent sub-slot. In other words, the determining that there is a collision between the sets of radio resources of the at least two of the second control signals in a sub-slot of the wireless access interface further comprises determining that the sets of radio resources of the first of the at least two second control signals and the second of the at least two second control signals at least partially overlap in time. That is, in these implementations, PUCCH#1 and PUCCH#2 in FIG. 14 are NOT considered to be in collision and so they can both be transmitted independently.

### Flow Chart Representation

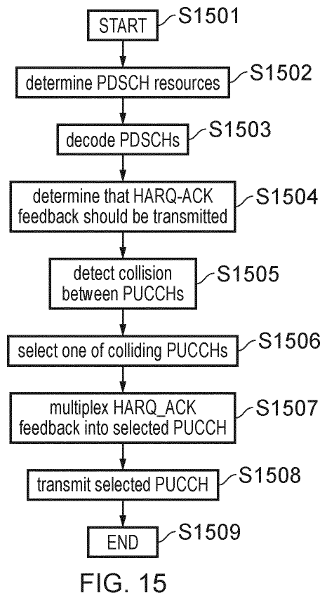

FIG. 15 shows a flow diagram illustrating a first example process of communications in a communications system in accordance with embodiments of the present technique. The process shown by FIG. 15 is a method of operating a communications device configured to transmit data to or receive data from an infrastructure equipment of a wireless communications network.

The method begins in step S1501. The method comprises, in step S1502, determining a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots. In step S1503, the method comprises decoding the plurality of downlink signals. The process then moves to step S1504, which involves determining that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface. Next, in step S1505, the method comprises determining that there is a collision between the sets of radio resources of at least two of the second control signals in a sub-slot of the wireless access interface. The process then comprises, in step S1506, selecting, in response to determining that there is a collision between the sets of radio resources of at least two of the second control signals, one of the at least two second control signals to carry the feedback signals which were to be carried by each of the at least two second control signals. In step S1507, the process comprises multiplexing the feedback signals which were to be carried by each of the at least two second control signals into the selected second control signal before, in step S1508, transmitting only the selected second control signal. The method ends in step S1509.

Those skilled in the art would appreciate that the method shown by FIG. 15 may be adapted in accordance with embodiments of the present technique. For example, other intermediate steps may be included in the method, or the steps may be performed in any logical order.

Though embodiments of the present technique have been described largely by way of the example communications system shown in FIG. 8, and in accordance with the examples of FIGS. 9 to 14, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to transmit data or receive data, the method comprising
determining a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots,
decoding the plurality of downlink signals,
determining that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface,
determining that there is a collision between the sets of radio resources of at least two of the second control signals in a sub-slot of the wireless access interface,
selecting, in response to determining that there is a collision between the sets of radio resources of at least two of the second control signals, one of the at least two second control signals to carry the feedback signals which were to be carried by each of the at least two second control signals,
multiplexing the feedback signals which were to be carried by each of the at least two second control signals into the selected second control signal, and
transmitting only the selected second control signal.

Paragraph 2. A method according to Paragraph 1, wherein the selecting the one of the at least two second control signals to carry the feedback signals which were to be carried by each of the at least two second control signals comprises
determining which of the one of the at least two second control signals is associated with the most recently received one of the plurality of downlink signals, and
selecting the determined one of the at least two second control signals as the selected second control signal.

Paragraph 3. A method according to Paragraph 2, wherein if the set of radio resources of the selected second control signal starts in a sub-slot that is not a first sub-slot of one of the slots of the wireless access interface, the method comprises
transmitting the selected second control signal in the first sub-slot of the one of the slots of the wireless access interface.

Paragraph 4. A method according to any of Paragraphs 1 to 3, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining that the set of radio resources of one or more of the at least two second control signals extends between at least two of the plurality of sub-slots,
determining which of the one or more of the at least two second control signals starts in the earliest sub-slot of the plurality of sub-slots, and determining, from among the one or more of the at least two second control signals that starts in the earliest sub-slot of the plurality of sub-slots, which one is associated with the most recently received one of the plurality of downlink signals, and
selecting the determined one of the one or more of the at least two second control signals as the selected second control signal.

Paragraph 5. A method according to any of Paragraphs 1 to 4, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
selecting the one of the subset of the at least two second control signals having a highest capacity as the selected second control signal.

Paragraph 6. A method according to Paragraph 5, wherein the capacity is based on a temporal length of each of the second control signals.

Paragraph 7. A method according to Paragraph 5 or Paragraph 6, wherein the capacity is based on a number of physical resource blocks forming each of the second control signals.

Paragraph 8. A method according to any of Paragraphs 5 to 7, wherein the capacity is based on a modulation scheme used to form each of the second control signals.

Paragraph 9. A method according to any of Paragraphs 5 to 8, wherein the capacity is based on a coding rate of each of the second control signals.

Paragraph 10. A method according to any of Paragraphs 1 to 9, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
selecting the one of the subset of the at least two second control signals that is scheduled to end at the earliest time as the selected second control signal.

Paragraph 11. A method according to Paragraph 10, wherein the selecting the one of the subset of the at least two second control signals that is scheduled to end at the earliest time as the selected second control signal comprises
determining that the one of the subset of the at least two second control signals is scheduled to end at an earlier time relative to the start of the sub-slot in which the one of the subset of the at least two second control signals starts than each of the others of the subset of the at least two second control signal are scheduled to end relative to the start of the sub-slots in which they start.

Paragraph 12. A method according to any of Paragraphs 1 to 11, comprising receiving, via the wireless access interface, a plurality of first control signals each comprising an indication of the set of radio resources of the wireless access interface in which the communications device is to receive one of the plurality of downlink signals, and
wherein the determining of the sets of radio resources of the wireless access interface in each of which the communications device is to transmit one of the plurality of second control signals comprises receiving, in the first control signals, indications of the sets of radio resources of the wireless access interface in which the communications device is to transmit the uplink control signals.

Paragraph 13. A method according to Paragraph 12, wherein the first control signals are Downlink Control Information, DCI, signals.

Paragraph 14. A method according to any of Paragraphs 1 to 13, comprising receiving, via the wireless access interface, Radio Resource Control, RRC, signalling indicating the sets of radio resources of the wireless access interface in which the communications device is to receive the downlink signals, and
wherein the determining of the sets of radio resources of the wireless access interface in each of which the communications device is to transmit one of the plurality of second control signals comprises receiving, via the wireless access interface, RRC signalling indicating the sets of radio resources of the wireless access interface in which the communications device is to transmit the uplink control signals.

Paragraph 15. A method according to any of Paragraphs 1 to 14, wherein the determining that there is a collision between the sets of radio resources of the at least two of the second control signals in a sub-slot of the wireless access interface comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
determining that the sets of radio resources of at least two of the subset of the at least two second control signals at least partially overlap in time.

Paragraph 16. A method according to any of Paragraphs 1 to 15, wherein the determining that there is a collision between the sets of radio resources of the at least two of the second control signals in a sub-slot of the wireless access interface comprises
determining that the sets of radio resources of the at least two second control signals are located within a plurality of the sub-slots of the wireless access interface,
determining that a first of the at least two second control signals that starts in a first of the plurality of sub-slots extends into a second of the plurality of sub-slots, and
determining that a second of the at least two second control signals starts in the second of the plurality of sub-slots.

Paragraph 17. A method according to Paragraph 16, wherein the determining that there is a collision between the sets of radio resources of the at least two of the second control signals in a sub-slot of the wireless access interface further comprises
determining that the sets of radio resources of the first of the at least two second control signals and the second of the at least two second control signals at least partially overlap in time.

Paragraph 18. A communications device configured to transmit data or receive data, the communications device comprising
transceiver circuitry configured to transmit signals and receive signals via a wireless access interface, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots,
to decode the plurality of downlink signals,
to determine that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface determined by the communications device,
to determine that there is a collision between the sets of radio resources of at least two of the second control signals in a sub-slot of the wireless access interface,
to select, in response to determining that there is a collision between the sets of radio resources of at least two of the second control signals, one of the at least two second control signals to carry the feedback signals which were to be carried by each of the at least two second control signals,
to multiplex the feedback signals which were to be carried by each of the at least two second control signals into the selected second control signal, and
to transmit only the selected second control signal.

Paragraph 19. Circuitry for a communications device configured to transmit data or receive data, the communications device comprising
transceiver circuitry configured to transmit signals and receive signals via a wireless access interface, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots,
to decode the plurality of downlink signals,
to determine that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface determined by the communications device,
to determine that there is a collision between the sets of radio resources of at least two of the second control signals in a sub-slot of the wireless access interface,
to select, in response to determining that there is a collision between the sets of radio resources of at least two of the second control signals, one of the at least two second control signals to carry the feedback signals which were to be carried by each of the at least two second control signals,
to multiplex the feedback signals which were to be carried by each of the at least two second control signals into the selected second control signal, and
to transmit only the selected second control signal.

Paragraph 20. A method of operating an infrastructure equipment configured to transmit data or receive data, the method comprising
providing a wireless access interface formed of a plurality of time divided slots, each of the time divided slots being further divided into two or more sub-slots,
determining a plurality of sets of radio resources of a wireless access interface in each of which the infrastructure equipment is to transmit of a plurality of downlink signals,
transmitting the plurality of downlink signals,
determining that the infrastructure equipment is to receive, for each of the transmitted downlink signals, a feedback signal indicating for the each of the downlink signals whether or not the each of the downlink signals was successfully received, wherein the infrastructure equipment is to receive the feedback signals within a plurality of second control signals, one or more of the feedback signals to be received within each of the second control signals, each of the second control signals being associated with at least one of the plurality of downlink signals and being received by the infrastructure equipment in a set of radio resources of the wireless access interface,
determining that there is a collision between the sets of radio resources of at least two of the second control signals in a sub-slot of the wireless access interface,
determining, in response to determining that there is a collision between the sets of radio resources of at least two of the second control signals, that one of the at least two second control signals will carry the feedback signals which were to be carried by each of the at least two second control signals, and
receiving the determined one of the second control signals.

Paragraph 21. An infrastructure equipment configured to transmit data or receive data, the infrastructure equipment comprising
transceiver circuitry configured to transmit signals and receive signals via a wireless access interface provided by the infrastructure equipment, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the infrastructure equipment is to transmit of a plurality of downlink signals,
to transmit the plurality of downlink signals,
to determine that the infrastructure equipment is to receive, for each of the transmitted downlink signals, a feedback signal indicating for the each of the downlink signals whether or not the each of the downlink signals was successfully received, wherein the infrastructure equipment is to receive the feedback signals within a plurality of second control signals, one or more of the feedback signals to be received within each of the second control signals, each of the second control signals being associated with at least one of the plurality of downlink signals and being received by the infrastructure equipment in a set of radio resources of the wireless access interface,
to determine that there is a collision between the sets of radio resources of at least two of the second control signals in a sub-slot of the wireless access interface,
to determine, in response to determining that there is a collision between the sets of radio resources of at least two of the second control signals, that one of the at least two second control signals will carry the feedback signals which were to be carried by each of the at least two second control signals, and
to receive the determined one of the second control signals.

Paragraph 22. Circuitry for an infrastructure equipment configured to transmit data or receive data, the infrastructure equipment comprising
transceiver circuitry configured to transmit signals and receive signals via a wireless access interface provided by the infrastructure equipment, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the infrastructure equipment is to transmit of a plurality of downlink signals,
to transmit the plurality of downlink signals,
to determine that the infrastructure equipment is to receive, for each of the transmitted downlink signals, a feedback signal indicating for the each of the downlink signals whether or not the each of the downlink signals was successfully received, wherein the infrastructure equipment is to receive the feedback signals within a plurality of second control signals, one or more of the feedback signals to be received within each of the second control signals, each of the second control signals being associated with at least one of the plurality of downlink signals and being received by the infrastructure equipment in a set of radio resources of the wireless access interface,
to determine that there is a collision between the sets of radio resources of at least two of the second control signals in a sub-slot of the wireless access interface,
to determine, in response to determining that there is a collision between the sets of radio resources of at least two of the second control signals, that one of the at least two second control signals will carry the feedback signals which were to be carried by each of the at least two second control signals, and
   to receive the determined one of the second control signals.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, v14.3.0.
[3] RP-190726, “Physical layer enhancements for NR ultra-reliable and low latency communication (URLLC)”, Huawei, HiSilicon, RAN#83.
   R1-1908646, “UCI enhancements for eURLLC,” Intel Corporation, RAN1#98.
   R1-1908052, “UCI enhancements for URLLC,” Huawei, HiSilicon, RAN1#98.
   R1-1908437, “On UCI Enhancements for NR URLLC,” Nokia, Nokia Shanghai Bell, RAN1#98.

1. A method of operating a communications device configured to transmit data or receive data, the method comprising
determining a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots,
decoding the plurality of downlink signals,
determining that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface,
determining that there is a collision between the sets of radio resources of at least two of the second control signals in a sub-slot of the wireless access interface,
selecting, in response to determining that there is a collision between the sets of radio resources of at least two of the second control signals, one of the at least two second control signals to carry the feedback signals which were to be carried by each of the at least two second control signals,
multiplexing the feedback signals which were to be carried by each of the at least two second control signals into the selected second control signal, and
transmitting only the selected second control signal.

2. A method according to claim 1, wherein the selecting the one of the at least two second control signals to carry the feedback signals which were to be carried by each of the at least two second control signals comprises
determining which of the one of the at least two second control signals is associated with the most recently received one of the plurality of downlink signals, and
selecting the determined one of the at least two second control signals as the selected second control signal.

3. A method according to claim 2, wherein if the set of radio resources of the selected second control signal starts in a sub-slot that is not a first sub-slot of one of the slots of the wireless access interface, the method comprises
transmitting the selected second control signal in the first sub-slot of the one of the slots of the wireless access interface.

4. A method according to claim 1, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining that the set of radio resources of one or more of the at least two second control signals extends between at least two of the plurality of sub-slots,
determining which of the one or more of the at least two second control signals starts in the earliest sub-slot of the plurality of sub-slots, and determining, from among the one or more of the at least two second control signals that starts in the earliest sub-slot of the plurality of sub-slots, which one is associated with the most recently received one of the plurality of downlink signals, and
selecting the determined one of the one or more of the at least two second control signals as the selected second control signal.

5. A method according to claim 1, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
selecting the one of the subset of the at least two second control signals having a highest capacity as the selected second control signal.

6. A method according to claim 5, wherein the capacity is based on a temporal length of each of the second control signals.

7. A method according to claim 5, wherein the capacity is based on a number of physical resource blocks forming each of the second control signals.

8. A method according to claim 5, wherein the capacity is based on a modulation scheme used to form each of the second control signals.

9. A method according to claim 5, wherein the capacity is based on a coding rate of each of the second control signals.

10. A method according to claim 1, wherein the selecting the one of the at least two second control signals to carry the feedback signals which were to be carried by each of the at least two second control signals comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
selecting the one of the subset of the at least two second control signals that is scheduled to end at the earliest time as the selected second control signal.

11. A method according to claim 10, wherein the selecting the one of the subset of the at least two second control signals that is scheduled to end at the earliest time as the selected second control signal comprises
determining that the one of the subset of the at least two second control signals is scheduled to end at an earlier time relative to the start of the sub-slot in which the one of the subset of the at least two second control signals starts than each of the others of the subset of the at least two second control signal are scheduled to end relative to the start of the sub-slots in which they start.

12. A method according to claim 1, comprising receiving, via the wireless access interface, a plurality of first control signals each comprising an indication of the set of radio resources of the wireless access interface in which the communications device is to receive one of the plurality of downlink signals, and
wherein the determining of the sets of radio resources of the wireless access interface in each of which the communications device is to transmit one of the plurality of second control signals comprises receiving, in the first control signals, indications of the sets of radio resources of the wireless access interface in which the communications device is to transmit the uplink control signals.

13. A method according to claim 12, wherein the first control signals are Downlink Control Information, DCI, signals.

14. A method according to claim 1, comprising receiving, via the wireless access interface, Radio Resource Control, RRC, signalling indicating the sets of radio resources of the wireless access interface in which the communications device is to receive the downlink signals, and
wherein the determining of the sets of radio resources of the wireless access interface in each of which the communications device is to transmit one of the plurality of second control signals comprises receiving, via the wireless access interface, RRC signalling indicating the sets of radio resources of the wireless access interface in which the communications device is to transmit the uplink control signals.

15. A method according to claim 1, wherein the determining that there is a collision between the sets of radio resources of the at least two of the second control signals in a sub-slot of the wireless access interface comprises
determining that the sets of radio resources of the at least two second control signals are located within a plurality of the sub-slots of the wireless access interface,
determining a subset of the at least two second control signals, the subset of the at least two second control signals comprising, for each of the plurality of the sub-slots comprising the sets of radio resources of the at least two second control signals, the one of the at least two second control signals which is associated with the most recently received one of the plurality of downlink signals from among those of the at least two second control signals that start in that sub-slot, and
determining that the sets of radio resources of at least two of the subset of the at least two second control signals at least partially overlap in time.

16. A method according to claim 1, wherein the determining that there is a collision between the sets of radio resources of the at least two of the second control signals in a sub-slot of the wireless access interface comprises
determining that the sets of radio resources of the at least two second control signals are located within a plurality of the sub-slots of the wireless access interface,
determining that a first of the at least two second control signals that starts in a first of the plurality of sub-slots extends into a second of the plurality of sub-slots, and
determining that a second of the at least two second control signals starts in the second of the plurality of sub-slots.

17. A method according to claim 16, wherein the determining that there is a collision between the sets of radio resources of the at least two of the second control signals in a sub-slot of the wireless access interface further comprises
determining that the sets of radio resources of the first of the at least two second control signals and the second of the at least two second control signals at least partially overlap in time.

18. A communications device configured to transmit data or receive data, the communications device comprising
transceiver circuitry configured to transmit signals and receive signals via a wireless access interface, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the communications device is to receive one of a plurality of downlink signals, wherein the wireless access interface is formed of a plurality of time divided slots, each of the time divided slots being further divided into two or more sub-slots,
to decode the plurality of downlink signals,
to determine that the communications device should transmit, for each of the downlink signals, a feedback signal indicating for the each of the downlink signals whether or not the each of the downlink signals was successfully received, wherein the communications device is to transmit the feedback signals within a plurality of second control signals, one or more of the feedback signals to be transmitted within each of the second control signals, each of the second control signals being associated with at least one of the plurality of downlink signals and being transmitted by the communications device in a set of radio resources of the wireless access interface determined by the communications device,
to determine that there is a collision between the sets of radio resources of at least two of the second control signals in a sub-slot of the wireless access interface,
to select, in response to determining that there is a collision between the sets of radio resources of at least two of the second control signals, one of the at least two second control signals to carry the feedback signals which were to be carried by each of the at least two second control signals,
to multiplex the feedback signals which were to be carried by each of the at least two second control signals into the selected second control signal, and
to transmit only the selected second control signal.

19.-20. (canceled)

21. An infrastructure equipment configured to transmit data or receive data, the infrastructure equipment comprising
transceiver circuitry configured to transmit signals and receive signals via a wireless access interface provided by the infrastructure equipment, wherein the wireless access interface is formed of a plurality of time divided slots, each of the time divided slots being further divided into two or more sub-slots, and
controller circuitry configured in combination with the transceiver circuitry
to determine a plurality of sets of radio resources of a wireless access interface in each of which the infrastructure equipment is to transmit of a plurality of downlink signals,
to transmit the plurality of downlink signals,
to determine that the infrastructure equipment is to receive, for each of the transmitted downlink signals, a feedback signal indicating for the each of the downlink signals whether or not the each of the downlink signals was successfully received, wherein the infrastructure equipment is to receive the feedback signals within a plurality of second control signals, one or more of the feedback signals to be received within each of the second control signals, each of the second control signals being associated with at least one of the plurality of downlink signals and being received by the infrastructure equipment in a set of radio resources of the wireless access interface,
to determine that there is a collision between the sets of radio resources of at least two of the second control signals in a sub-slot of the wireless access interface,
to determine, in response to determining that there is a collision between the sets of radio resources of at least two of the second control signals, that one of the at least two second control signals will carry the feedback signals which were to be carried by each of the at least two second control signals, and
to receive the determined one of the second control signals.

22. (canceled)
